(19) United States
(12) Patent Application Publication
(10) Pub. No.: US 2011/0040875 A1
(43) Pub. Date: Feb. 17, 2011

(54) System And Method For Inter-domain Information Transfer

(76) Inventors: Martin SCHOLZ, San Francisco, CA (US); Craig Peter SAYERS, Menlo Park, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/541,794

(22) Filed: Aug. 14, 2009

(51) Int. Cl. G06F 15/173

(52) U.S. Cl. 709/225

(57) ABSTRACT

System and method is disclosed for inter-domain information transfer. The method discloses defining a sharing profile, including a set of rules for whether and how to share information between a set of independent domains; exchanging information with a first domain in the set, thereby generating a first domain data set; and sharing information from the first domain data set with a second domain in the set which is independent from the first domain, according to the rules in the sharing profile. The system discloses a browser plug-in for generating a sharing profile, including rules for whether and how to share information between a set of independent domains; and a domain browser for sharing domain data set information between domains in the set according to the rules in the sharing profile.

### BACKGROUND OF THE INVENTION

1. Field of the Invention

The present invention relates generally to systems and methods for information transfer between domains.

1. Discussion of Background Art

With a great deal of business being conducted over networks, there is a tension between creating an environment which facilitates “ease of use” with one that also preserves a certain degree of privacy and user control. What is needed is a system and method for inter-domain information transfer that overcomes the problems of the prior art.

### BRIEF DESCRIPTION OF THE DRAWINGS

Some embodiments of the invention are described, by way of example, with respect to the following figures:

FIG. 1 is a first main embodiment of a system for inter-domain information transfer;

FIG. 2 is a second main embodiment of the system for inter-domain information transfer;

FIG. 3 is a set of data structure diagrams for one or more embodiments of the system for inter-domain information transfer; and

FIG. 4 is a flowchart of one embodiment of a method for inter-domain information transfer.

### DETAILED DESCRIPTION OF THE PREFERRED EMBODIMENT

Often when users visit a web site, the site stores and maintains certain user transaction information for facilitating the user's interaction with the site. This transaction information can be stored in cookies, term/value pairs, and URLs saved on the user's computer, or perhaps on the web site's server, if a user has an account with the site. To preserve privacy, however, the user's transaction information with a prior site is not transferred to new web sites that the user browses. As a result, often the user needs to reenter the same or similar information many times over, as the user visits each different web site.

For example, when a user is creating a travel itinerary, the user visits a first travel web site and provides the first web site with a set the travel information (e.g. dates, destinations, departure and arrival points, seating and hotel preferences, etc). Now when the user wishes to visit a second travel site to compare trip prices, the second site will necessarily request a very similar set of travel information. The user then needs to manually re-enter the same travel information at this second site, as well as at every subsequent travel site the user visits.

It would be advantageous if the user did not need to manually and laboriously re-enter the same, or a very similar, set of travel itinerary information at each and every travel site. It would also be advantageous for the user to maintain some control over which information is shared between sites, since in some cases information sharing is a undesirable (e.g. to prevent an advertising site from tracking the user's shopping behavior). Indeed web browsers are often preferably designed to make unrestricted information sharing between web site hosts in different domains difficult so as not to create a security hole. Thus there is a need for the selective and controlled sharing of user information.

The present invention provides a system and method for sharing information between independent web domains while also maintaining a predetermined level of privacy and control over the user's information, and remedies many, if not all, of the problems discussed above.

Some of the advantages of the present invention include: providing a solution which fits with the common design pattern of storing temporary user information and state in cookies; not requiring users to “Accept third-party cookies”; giving the user more control over personal information sharing; and secure methods and systems for taking information already stored about the user and distributing it to other sites.

Details of the present invention are now discussed.

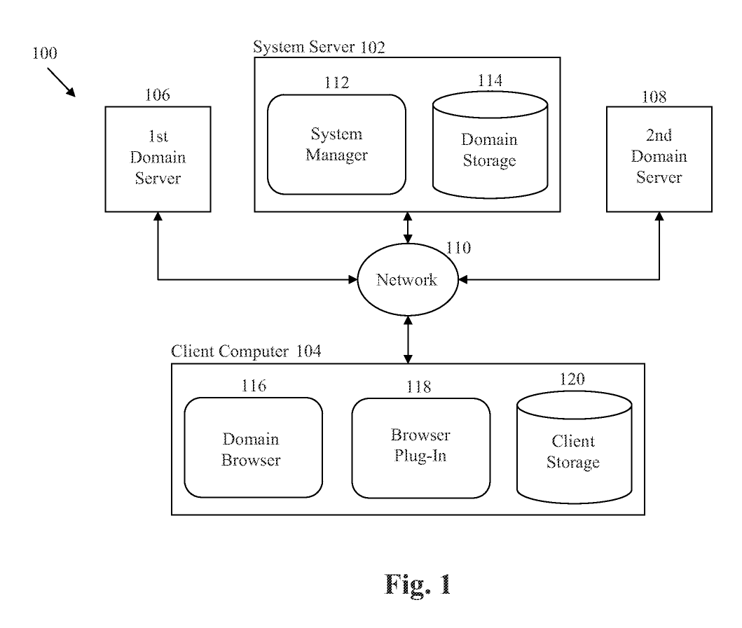

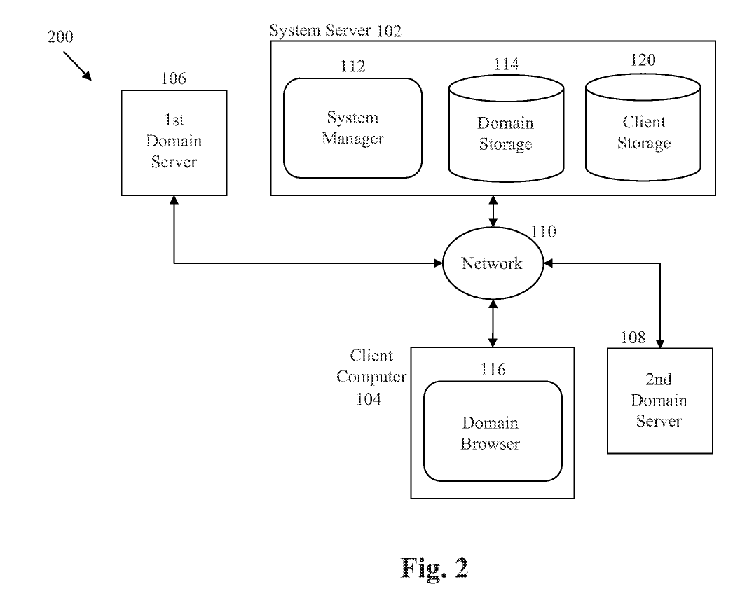

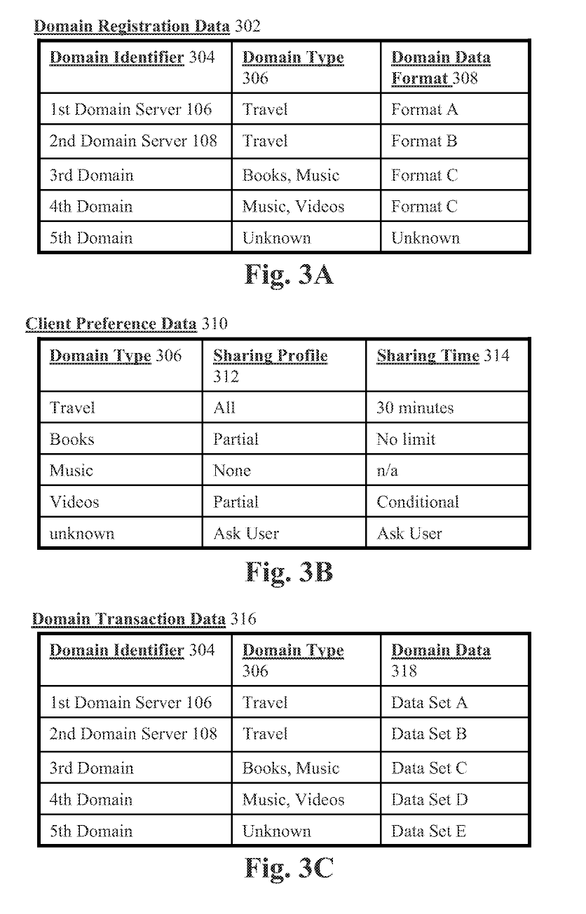

FIG. 1 is a first main embodiment 100 of a system for inter-domain information transfer. FIG. 2 is a second main embodiment 200 of the system for inter-domain information transfer. FIG. 3 is a set of data structure diagrams for one or more embodiments of the system for inter-domain information transfer. To facilitate understanding, FIGS. 1, 2, and 3 are discussed together.

The system includes a system server 102, a client computer 104, a 1st domain server 106, and a 2nd domain server 108, each connected to and communicating over a network 110. The 1st and 2nd domain servers 106 and 108 are independent. “Independent domains” are herein defined as data domains (e.g. web sites) that either do not share any, or share only a subset of user information independently acquired by each of the data domains. This limitation on data sharing is typically by design so that user privacy is preserved to some degree. “Users” are herein defined as any computer, resource and/or person who transacts information with the independent domains. Some “users” can be automated programs.

Note that while in the embodiment now described the system server 102, client computer 104, and the 1st and 2nd domains 106 and 108 are impliedly hosted on separate computers, in other embodiments of the present invention all of these structures can be effected on a single computer, as long as the 1st and 2nd domains 106 and 108 are independent, as herein defined.

Two main embodiments 100 and 200 of the present invention are now discussed. In the first main embodiment 100, shown in FIG. 1, the client computer 104 includes a domain browser 116, a browser plug-in 118, and client storage 120. In the second main embodiment 200, shown in FIG. 2, the client computer 104 includes the domain browser 116, but does not include the browser plug-in 118, and the client storage 120 is now on the system server 102. Those skilled in the art will recognize that many more embodiments of the invention can be created which are a blend of the first and second main embodiments, depending upon where domain and client information is stored and how such information is managed. Such other embodiments may also include an embodiment where there is no system sever 102, and the client computer 104 is the focal point of the system. The first main embodiment is now discussed.

In the first main embodiment, shown in FIG. 1, the system server 102 includes a system manager 112 and domain storage 114. The system manager 112 contacts a set of domains, over the network 110, and collects a set of domain registration data 302 for each of the domain.

In FIG. 3A, the collected domain registration data 302 includes fields for a domain identifier 304, a domain type 306, and a domain data format 308. In one embodiment, a virtual name can be listed as the domain identifier 304, while in another embodiment a web address may be the domain identifier 304. In the example shown in FIG. 3A, the 1st and 2nd domain server 106 and 108 labels are listed as their respective domain identifiers 304.

The domain type 306 corresponds to a predefined set of labels which categorize the subject matter, functionality, etc. of the identified domains. Each domain may be identified with more than one domain type 306, including: travel, books, music, video, general retail, etc. For example in FIG. 3A, the 1st and 2nd domain servers 106 and 108 are both identified as a “travel” types, likely meaning that their primary subject matter and functionality are in the area of arranging transportation, hotel, and activities for business or leisure travelers. The definition for each “type” label can vary with each embodiment of the system 100. Note that in FIG. 3A, the 3rd and 4th domains both have a domain type 306 that includes “Music”, as well as other non-overlapping types (e.g. “books” and “videos”). Also, note that the 5th domain has a domain type 306 that is “unknown”. An “unknown” domain type 306 may indicate that the 5th domain is not currently aware that the system 100 exists or is not participating in the operation of the system 100.

The domain data format 308 is provided by each domain to the system server 102. In general, domain data (e.g. cookies) includes small files and/or data sets generated and updated by web servers, such as the 1st and 2nd domain servers 106 and 108, and stored on web browsers such as the client computer 104, so as to facilitate interactions between the server and browser. The domain data typically contains user browsing, selection, and provided information (e.g. product type, date, and user-supplied details). Domain data structures typically include a set of “term” and “value” pairs, however, the labeling and meaning of such terms and values can vary widely from one web server to another. Some domain data however may have a more “standardized” format.

The domain data format 308 typically varies depending upon the domain. For example, the domain data format 308 may be a cookie format, a set of name/value pairs, or URL data. The set of name/value pairs could be a textual list, encoded in JSON, XML, or RDF, or in some other standard format. The URL data can be parameters extracted from a web page URL. For example, a URL like “someTravelSiteA/search?from=LAX&to=LAS&ticket=return&date=090602&hpDat aFormat=A&hpDataType=travel” contain domain transaction data 316 such as, “from”, “to”, “ticket” type, and “date”. Thus the domain data formats 308 must provide a definition for at least some of the “terms” or “parameters” in the domain data, and also provide an associated range of permissible “values”. This information will be used by the system 100 to remap the domain data set between independent domains, as will be discussed.

FIG. 3A, shows that domain data format 308 for the 1st domain server 106 is “Format A” and for the 2nd domain server 108 is “Format B”. The 3rd and 4th domains both have “Format C” as their domain data format 308, suggesting that perhaps “Format C” is somewhat “standardized” and thus could be used by many other domains as well. Note that domain data construction, to be discussed below, is simplified for domain data formats 308 which are more standardized. The 5th domain has an “unknown” domain data format 308.

The system manager 112 stores the set of domain registration data 302 in the domain storage 114.

Next the client computer 104 uses the domain browser 116 to browse for domains over the network 110. The client computer 104 then connects to the 1st domain server 106 and an exchange of information between the client 104 and the server 106 commences. In the course of one embodiment of this exchange, the 1st domain server 106 informs the client computer 104 that a plug-in is available for download from the system server 102, thereby facilitating client 104 interactions with other domains having a similar “type”, such as, for example, the 2nd domain server 108. The client computer 104 then contacts the system manager 112 in the system server 102 and downloads the browser plug-in 118. In alternate embodiments, the client computer 104 can acquire the browser plug-in 118 software in a variety of ways, including: having the browser plug-in 118 pre-installed on the client computer 104, or responding to a solicitation received directly from the system manager 112.

Once operational on the client computer 104, the browser plug-in 118 engages a user of the client computer 104 in a dialog which solicits a set of client preference data 310, which is akin to a user privacy profile. Note that if the browser plug-in 118 software was pre-installed on the client computer 104, or was acquired directly from the system manager 112, the dialog soliciting the set of client preference data 310 would have preferably occurred before the client computer 104 browsed for domains over the network 110, as just described above. The client preference data 310 is stored in the client storage 120.

The client preference data 310 includes the domain type 306, a sharing profile 312, and a sharing time 314 for a set of domains contacted over the network. The domain type 306 has already been discussed above. The sharing profile 312 specifies a set of rules for sharing information between independent domains, such as domain servers 106 and 108. Those skilled in the art will recognize that there are many different ways of creating and expressing the sharing profile 312. One way is to have the user answer a set of questions for each domain type 306. Another way is to have the user select a “privacy level” in which a default sharing profile 312 is downloaded from the system manager 112, but which the user can modify.

FIG. 3B lists some example sharing profiles 312 which are generically labeled as: “All” (i.e. share everything), “Partial” (i.e. share selected information), “None” (i.e. share nothing), and “Ask User” (i.e. the user is asked if certain information can be shared). The meaning of these labels varies with a particular instance of the system 100 and the domain type 306. For example, in FIG. 3B, the “All” sharing profile 312 specified for the “Travel” domain type 306 can be defined as permitting sharing of a user's airline, hotel, side trips, and contact information. The “Partial” sharing profile 312 specified for the “Books” domain type 306 can be defined as permitting sharing of a user's book selections, but not the user's contact information. In some embodiments of the invention, “All” and/or “Partial” can also refer to sharing different information between some or all of the different domain types 306. In other embodiments, the sharing profile 312 can specify selective sharing of user information between sites on which the user has a user account, with user name and password protection. User accounts can be identified by looking for https logins.

The sharing time 314 specifies temporal boundaries for when and how long information is shared between independent domains. The temporal boundaries permit sharing in accordance with the sharing profile 312 either from a present time to a specified time in the past, or between a set of user specified dates and times that extend into the past as well as the future. Such temporal limits ensure that outdated information is not shared between domains. For example, in FIG. 3B, the user has specified that: “travel” domain types 306 can share information for up to 30 minutes; “book” domain types 306 can share information at any time; “video” domain types 306 can share information depending upon a predetermined condition (e.g. “until” the user makes a purchase); and “unknown” domain types 306 must ask the user for how long to share information. With the inclusion of sharing time 314 in the client preference data 310, users can scrub information sharing by just waiting for a particular sharing time 314 to expire.

Once the client preference data 310 is collected, the client computer 104 resumes the exchange of information with the 1st domain server 106, and in the background the browser plug-in 118 collects a set of domain transaction data 316. The domain transaction data 316 includes the domain identifier 304, the domain type 306, and domain data 318. The domain identifier 304 has already been discussed, as has the domain type 306. It is worth mentioning, however, that since the 1st domain server 106 has “registered” with system manager 112 in the system server 102, the domain type 306 for the 1st domain server 106 is downloaded from the domain registration data 302 on the system server 102.

The domain data 318 is a data set of transactional information (e.g. a cookie) transmitted from the domain server to the client computer 104. For example, in FIG. 3C, the 1st domain server 106 has sent back “Data Set A” to the client computer 104. “Data Set A” contains the user session information between the client computer 104 and the 1st domain server 106, which since the 1st domain server 106 is a “travel” type, likely contains information such as the user's airport flight number and departure date. Note that the saved domain transaction data 316 can also be thought of as a domain visitation history for the client computer 104. The domain transaction data 316 is stored in the client storage 120 by the browser plug-in 118.

Next the client computer 104 uses the domain browser 116 to browse for a next domain over the network 110, such as the 2nd domain server 108. The browser plug-in 118 searches for the 2nd domain server 108 domain identifier 304 in the domain registration data 302. If found in the domain registration data 302, the browser plug-in 118 compares the domain type 306 for the 2nd domain server 108 with that of the 1st domain server 106, which the user had previously navigated to. In an alternate embodiment, the 2nd domain server 108 directly tells the browser plug-in 118 what the 2nd domain server's 108 domain type 306 is.

If the 1st domain server 106 and 2nd domain server 108 have the same domain type 306, the browser plug-in 118 accesses the client preference data 310 in the client storage 120 to determine what information can be shared and for how long from the sharing profile 312 and the sharing time 314 respectively. If the user has not requested to be “asked” before information is shared, the browser plug-in 118 will automatically, but selectively, share information between the 1st and 2nd domain servers 106 and 108 in accordance with the client preference data 310.

Upon a request from the 2nd domain server 108 to the browser plug-in 118 for transactional information associated with the 1st domain server 106, the browser plug-in 118 accesses the domain data 318 “Data Set A” within the domain transaction data 316 for the 1st domain server 106. The browser plug-in 118 will then access the domain data format 308 “Format A” within the domain registration data 302 for the 1st domain server 106, and “Format B” for the 2nd domain server 108. Next, using the domain data format 308 information (i.e. “Format A” and “Format B”), the browser plug-in 118 converts (i.e. remaps) “Data Set A” from the 1st domain server 106 into a “Data Set B” (see FIG. 3C) for the 2nd domain server 108.

The browser plug-in 118 then sends “Data Set B” to the 2nd domain server 108, thereby sharing information between the two independent domains (i.e. 106 and 108). As a result, the system 100 frees the user of the burden of having to enter what would essentially be the same information.

For example, domain data format 308 be in the form of a URL, the browser plug-in 118 first detects that the domain browser 116 is about to do a “HTTP GET” of the URL, and rewrites selected parameters within the URL before the “HTTP GET” is then permitted to be executed.

In other embodiments of the present invention, the browser plug-in 118 searches all of the domain data 318 available within the domain transaction data 316 so as to satisfy the 2nd domain server's 108 request for information. The browser plug-in 118 will follow the rules in the client preference data 310 during this search. Thus, for example, depending upon the system's 100 implementation, “Data Set B” can either be a complete or partial remap of the domain data 318. “Data Set B” will be a complete remap of “Data Set A” if the 2nd domain server 108 asks the browser plug-in 118 for all of the transactional information available from the user's interaction with the 1st domain server 106. “Data Set B” may be a partial remap of the various domain data 318 (e.g. Data Sets A, B, C, D and E), if the 2nd domain server 108 only asks the browser plug-in 118 for specific information that may be stored in the domain data 318.

At some point, should the client computer 104 contact the 5th domain, shown in FIG. 3A, both the domain type 306 and the domain data format 308 for the 5th domain will be “unknown”. In response, the browser plug-in 118 preferably invites the 5th domain to contact the system manager 112 in the system server 102 and register, thereby facilitating client 104 interactions with the 5th domain in the future.

Should the 5th domain decline to participate in the system 100, the browser plug-in 118 can present the domain data 318 received from the 5th domain (i.e. “Data Set E”) to the user of the client computer 104. Then through a dialog between the user of the client computer 104 and the browser plug-in 118, the user is asked to suggest a domain type 306 for the 5th domain and also perhaps to identify all or part of the domain data format 308 for the 5th domain. Such a manually identified domain type 306 and domain data format 308 would then be transmitted to the system manager 112. The system manager 112 would also collect all of the manually identified domain types 306 and domain data formats 308 received from other client computers (not shown) and, in response, assign or revise the 5th domain's domain type 306 and domain data format 308, thereby “informally registering” an otherwise “unregistered” domain server. This derived information is then stored in the set of domain registration data 302 in the domain storage 114.

The second main embodiment 200 is shown in FIG. 2. Only the functional differences between the first and second main embodiments 100 and 200 are now discussed. The other functionality not distinguished remains the same or essentially the same as that discussed with respect to the first main embodiment 100.

In the second main embodiment 200, shown in FIG. 2 and introduced above, the client computer 104 includes the domain browser 116, but does not include the browser plug-in 118, and the client storage 120 is now on the system server 102. In this second embodiment 200, essentially all of the functionality of the browser plug-in 118 of the first embodiment 100 is removed from the client computer 104, and merged with the functionality of the system manager 112 in the system server 102. Also the information managed by the browser plug-in 118 in the client storage 120 is removed from the client computer 104 and stored in the system server 102. Thus in the second main embodiment 200 the client preference data 310 and the domain transaction data 316 are still stored in the client storage 120, but the client storage 120 is now on the system server 102.

Some functional differences of the second main embodiment 200 are now discussed. To begin, the client computer 104 “registers” with the system manager 112 on the system server 102. In response, the system manager 112 assigns the client computer 104 an “identification tag” (e.g. “User 637”), stored in a set of user registration data (not shown). The client computer 104 also downloads a very small file that instructs the domain browser 116 to transmit the “identification tag” to the domain servers (e.g. the 1st domain server 106) which the client computer 104 connects to using the domain browser 116.

Upon receipt of this “identification tag”, the 1st domain server 106 directly contacts the system manager 112 on the system server 102 and provides the system manager 112 with the “identification tag”. The system manager 112 then accesses the domain registration data 302, client preference data 310, and domain transaction data 316 and responds in a manner as discussed with respect to the first main embodiment 100 above. Thus the system manager 112 will directly provide the 1st domain server 106 with a “Data Set A” which has been generated by selectively accessing information from the user's “Data Sets B, C, D, and E” now stored on the system server 102.

Some of the advantages of this second main embodiment 200 include: enabling the user to provide their “identification tag” from many different client computers (not shown) since the system server 102 essentially acts as a service provider; the client computer 104 is not burdened with a variety of processing tasks and program files, which are now effected by the system server 102 which likely has much greater processing and storage resources; and better security protection from “malicious sites” that pretend to be of a certain “type” (e.g. travel) just to try and obtain the user's otherwise private “cookie” information.

The present invention also teaches many other embodiments which may be a blend of the first main embodiment 100 and the second main embodiment 200. Other embodiments may completely eliminate the system server 102 such that the invention is effected substantially by the client computer 104.

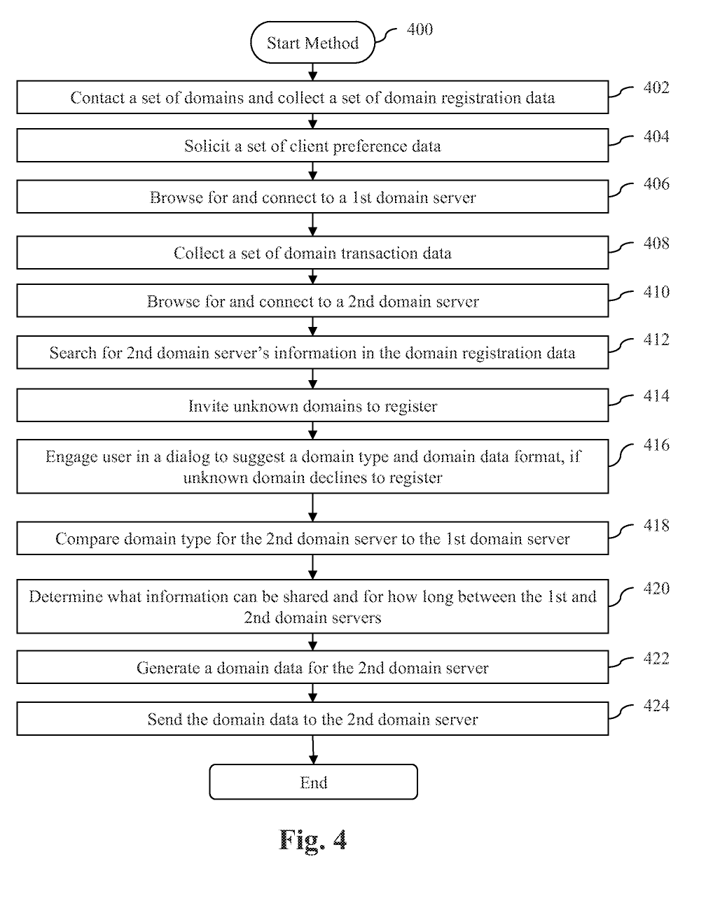

FIG. 4 is a flowchart of one embodiment of a method 400 for inter-domain information transfer. Those skilled in the art will recognize that while one embodiment of the present invention's method is now discussed, the material in this specification can be combined in a variety of ways to yield other embodiments as well. The method steps next discussed are to be understood within a context provided by this and other portions of this detailed description.

The method 400 begins in step 402, where the system manager 112 contacts a set of domains, 106 and 108, and collects a set of domain registration data 302, including the domain identifier 304, the domain type 306, and the domain data format 308. Next, in step 404, the user of the client computer 104 is engaged in a dialog which solicits a set of client preference data 310, which includes the domain type 306, the sharing profile 312, and the sharing time 314.

In step 406, the client computer 104 uses the domain browser 116 to browse for and connect to the 1st domain server 106. In step 408, a set of domain transaction data 316 is collected, which includes the domain identifier 304, the domain type 306, and the domain data 318.

Next in step 410, the client computer 104 uses the domain browser 116 to browse for the 2nd domain server 108. In step 412, the browser plug-in 116 searches for the 2nd domain server's 108 information in the domain registration data 302.

In step 414, if the domain type 306 and/or the domain data format 308 for the 2nd domain server 108 is “unknown”, then the 2nd domain server 108 is invited to register and provide its domain registration data 302. In step 416, if the 2nd domain server 108 declines to provide such registration data, the user of the client computer 104 is engaged in a dialog so as to suggest a domain type for the unknown domain and perhaps identify the domain data format 308 for the unknown domain.

In step 418 the domain type for the 2nd domain server is compared with that of the 1st domain server. Next in step 420, if the 1st domain server 106 and 2nd domain server 108 have the same domain type 306, the client preference data 310 is accessed to determine what information can be shared and for how long between the 1st and 2nd domain servers, 106 and 108.

In step 422, upon a request from the 2nd domain server 108 for transactional information likely to be associate with the client computer 104, a domain data 318 set is generated for the 2nd domain server from the 1st domain server's 106 domain data 318 set information as well as from any other domain data 318 sets associated with the client computer 104 and/or its user, in accordance with the rules in the client preference data 310. Then in step 424, the domain data 318 set is sent to the 2nd domain server, thereby sharing information between the two independent 1st and 2nd domain servers 106 and 108.

A set of files refers to any collection of files, such as a directory of files. A “file” can refer to any data object (e.g., a document, a bitmap, an image, an audio clip, a video clip, software source code, software executable code, etc.). A “file” can also refer to a directory (a structure that contains other files).

Instructions of software described above are loaded for execution on a processor (such as one or more CPUs <ref. #> in FIG. <#>). The processor includes microprocessors, microcontrollers, processor modules or subsystems (including one or more microprocessors or microcontrollers), or other control or computing devices. A “processor” can refer to a single component or to plural components.

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations thereof. It is intended that the following claims cover such modifications and variations as fall within the true spirit and scope of the invention.

What is claimed is:

1. A method, executed by a computer, for inter-domain information transfer, comprising:
defining a sharing profile, including rules for whether and how to share information between a set of independent domains;
exchanging information with a first domain in the set, thereby generating a first domain data set; and
sharing information from the first domain data set with a second domain in the set which is independent from the first domain, according to the rules in the sharing profile.

2. The method of claim 1,
wherein the steps of defining and sharing are effected using a web browser plug-in stored on a client computer, which is independent of the set of domains.

3. The method of claim 1:
wherein the set of independent domains are web sites that do not share information in transaction cookies that each domain generates.

4. The method of claim 1:
wherein the sharing profile rules include one from a group of: share everything; share selected information; share nothing; share information if the second domain is a password protected account; share information if the first and second domains have a same domain type; and asking a user for permission to share information.

5. The method of claim 1, further comprising:
defining a sharing time which specifies temporal boundaries for when and how long information is shared between the independent domains.

6. The method of claim 1:
further comprising:
receiving a first domain data format from the first domain;
receiving a second domain data format from the second domain; and
wherein sharing includes:
extracting information from the first domain data set using the first domain data format; and
generating a second domain data set for the second domain based on the extracted information from the first domain data set and the second domain data format.

7. The method of claim 1, wherein the sharing profile rules include:
assigning a set of domains to a domain type if the domains share at least one of a group of attributes including: product subject matter, service subject matter, and functionality; and
sharing information between domains having a same domain type.

8. The method of claim 7:
wherein the domain types include: travel, books, music, video, computer services, medical, and general retail.

9. The method of claim 7, further comprising:
inviting an unknown domain, having an unknown domain type and an unknown domain data format, to reveal its domain type and domain data format.

10. A system for inter-domain information transfer, comprising:
a browser plug-in for generating a sharing profile, including rules for whether and how to share information between a set of independent domains; and
a domain browser for sharing domain data set information between domains in the set according to the rules in the sharing profile.

11. The system of claim 10, further comprising wherein the set of independent domains includes a set of independent web sites.

12. The system of claim 10:
further comprising client preference data, having the sharing profile; and
wherein the sharing profile rules include one from a group of: share everything; share selected information; share nothing; share information if the second domain is a password protected account; share information if the first and second domains have a same domain type; and asking a user for permission to share information.

13. The system of claim 12:
wherein the client preference data, includes a sharing time; and
wherein the sharing time specifies temporal boundaries for when and how long information is shared between the independent domains.

14. The system of claim 10, further comprising:
a system server for receiving domain registration data from a first and second domain in the set of domains, wherein the registration data includes a first and second domain data format respectively; and
a client computer for hosting the browser plug-in and the domain browser, wherein:
the browser plug-in translates a first domain data set, stored in the first domain data format, from the first domain into a second domain data set for the second domain, using the second domain data format.

15. The system of claim 14:
wherein the domain registration data includes a first and second domain type corresponding to the first and second domain in the set of domains; and
wherein the browser plug-in translates the first domain data set into the second domain data set only if the first and second domains have a same domain type.

16. A system for inter-domain information transfer, comprising:
a system server having:
a set of user registration data, having a user identification tag and a corresponding user sharing profile, including rules for whether and how to share information between a set of independent domains; and
a system manager for sharing a first domain data set, generated in response to the user's interaction with a first domain, with a second domain that has sent the system manager the user identification tag, according to rules in the user sharing profile.

17. The system of claim 16:
further comprising, a client computer having a web browser to enable the user to provide the user identification tag to the first and second domains; and
wherein the first and second domains transmit the user identification tag to the system server so as to receive information according to the rules in the user sharing profile.

18. The system of claim 16, further comprising wherein the set of independent domains includes a set of independent web sites.

19. The system of claim 16:
wherein the sharing profile rules include one from a group of: share everything; share selected information; share nothing; share information if the second domain is a password protected account; share information if the first and second domains have a same domain type; and asking a user for permission to share information.

20. The system of claim 16:
wherein the user registration data, includes a sharing time; and
wherein the sharing time specifies temporal boundaries for when and how long information is shared between the independent domains.
